(19) United States
(12) Patent Application Publication
(10) Pub. No.: US 2024/0034607 A1
(43) Pub. Date: Feb. 1, 2024

(54) LANYARD AND PPE DETECTION SYSTEM

(71) Applicant: Oshkosh Corporation, Oshkosh, WI (US)

(72) Inventors: Prabhu Shankar, Oshkosh, WI (US); Matthew Seifarth, Oshkosh, WI (US); Michael Buhidar, Oshkosh, WI (US); Shashank Bhatia, Oshkosh, WI (US)

(21) Appl. No.: 18/361,669

(22) Filed: Jul. 28, 2023

Related U.S. Application Data
(60) Provisional application No. 63/393,531, filed on Jul. 29, 2022.

(51) Int. Cl. B66F 17/00; B66F 11/04; A62B 35/00

(52) U.S. Cl. CPC B66F 17/006; B66F 11/046; A62B 35/0075

(57) ABSTRACT

A lift device includes a chassis, a platform configured to support an operator, the platform including an attachment point configured to engage a lanyard to secure the operator to the platform, a lift assembly coupling the platform to the chassis and configured to raise the platform relative to the chassis, a sensor configured to provide sensor data indicative of engagement between the attachment point and the lanyard, and a controller operatively coupled to the sensor. The controller is configured to determine, based on the sensor data, if the lanyard is engaged with the attachment point. In response to a determination that the lanyard is not engaged with the attachment point, the controller is configured to at least one of (a) activate an alarm to provide a notification to alert the operator that the lanyard is not engaged with the attachment point or (b) limit movement of the lift device.

### CROSS-REFERENCE TO RELATED PATENT APPLICATION

This application claims the benefit of and priority to U.S. Provisional Application No. 63/393,531, filed on Jul. 29, 2022, the entire disclosure of which is hereby incorporated by reference herein.

### BACKGROUND

The present disclosure relates generally to the field of lift devices. More specifically, the present disclosure relates to sensor systems for lift devices.

Some lift devices include platforms that support an operator. Such platforms are often supported by boom assemblies that facilitate vertical and/or horizontal movement of the platform.

### SUMMARY

At least one embodiment relates to a lift device including a chassis, a platform configured to support an operator, the platform including an attachment point configured to engage a lanyard to secure the operator to the platform, a lift assembly coupling the platform to the chassis and configured to raise the platform relative to the chassis, a sensor configured to provide sensor data indicative of engagement between the attachment point and the lanyard, and a controller operatively coupled to the sensor. The controller is configured to determine, based on the sensor data, if the lanyard is engaged with the attachment point. In response to a determination that the lanyard is not engaged with the attachment point, the controller is configured to at least one of (a) activate an alarm to provide a notification to alert the operator that the lanyard is not engaged with the attachment point or (b) limit movement of the lift device.

Another embodiment relates to a control method including receiving image data from a camera having a field of view that includes a work area of a platform, determining, based on the image data, if a personal protective equipment (PPE) system is securing an operator to an attachment point of the platform, and in response to a determination that the PPE system is not securing the operator to the attachment point, controlling an alarm to provide a notification to alert the operator.

Another embodiment relates to a control method including receiving image data from a camera having a field of view that includes a work area of a platform, identifying, based on the image data, a first operator and a second operator present within the work area, determining, based on the image data, if a first harness is worn by the first operator and a first lanyard is coupling the first harness to the platform, determining, based on the image data, if a second harness is worn by the second operator and a second lanyard is coupling the second harness to the platform, determining that a personal protective equipment (PPE) system is not operational in response to at least one of (a) a determination that the first harness is not worn by the first operator, (b) the first lanyard is not coupling the first harness to the platform, (c) a determination that the second harness is not worn by the second operator, or (d) the second lanyard is not coupling the second harness to the platform, and limiting operation of a lift assembly to prevent upward movement of the platform in response to a determination that the PPE system is not operational.

Another embodiment relates to a lift device including a chassis, a platform configured to support a operator, a lift assembly coupling the platform to the chassis, an actuator configured to at least one of (a) move the platform relative to the chassis or (b) propel the chassis, a operator protection assembly, a sensor assembly, and a controller. The operator protection assembly includes a jacket, harness, and a lanyard. The jacket and harness are configured to be worn by an operator positioned on the platform. An attachment point of the platform is configured to receive a first end of the lanyard. The harness is configured to receive a second end of the lanyard. The sensor assembly includes a camera positioned on the platform. The camera is configured to provide image data to the controller. The controller is configured to, based on the image data, determine whether the first end of the lanyard is coupled to the attachment point of the platform. The controller is further configured to, based on the image data, determine whether the operator is wearing the jacket. The controller is further configured to, based on the image data, determine whether the second end of the lanyard is coupled to the harness. The controller is operatively coupled to the sensor and the actuator and configured to control the actuator in response to receiving the signal from the sensor.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a front perspective view of a boom lift, according to an exemplary embodiment;

FIG. 2 is a front perspective view of a platform assembly of the boom lift of FIG. 1, according to an exemplary embodiment;

FIG. 3 is a front view of a lanyard and personal protective equipment (PPE) system of the platform assembly of FIG. 2, according to an exemplary embodiment;

FIG. 4 is a depiction of various embodiments of the lanyard and harness of the lanyard and PPE system of FIG. 3;

FIG. 5 is a side view of the platform assembly of FIG. 2;

FIG. 6A is a perspective view of an attachment point of the platform assembly of FIG. 2, according to an exemplary embodiment;

FIG. 6B is a front perspective view of the platform assembly of FIG. 1 outfitted with several of the attachment points of FIG. 6A;

FIG. 7 is a rear perspective view of various alternative configurations of the platform assembly of FIG. 2, each having a different size;

FIG. 8 is a block diagram of a control system for the lanyard and PPE system of FIG. 3, according to an exemplary embodiment;

FIG. 9 is a flow diagram of a process for implementing the lanyard and PPE system of FIG. 3, according to an exemplary embodiment;

FIG. 10 is a depiction several images captured by a camera of the control system of FIG. 8 under various environmental conditions experienced by the lanyard and PPE system of FIG. 3; and

FIGS. 11A and 11B are block diagrams illustrating a neural network model for the lanyard and PPE system of FIG. 3, according to various exemplary embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a lift device includes a platform configured to support a operator, a chassis, and a lift assembly coupling the platform to the chassis. The operator may control the lift assembly to raise, lower, or otherwise move the platform through a operator interface coupled to the platform. In some embodiments, the operator may wear a personal protective equipment (PPE) assembly. For example, the PPE assembly may include a harness, which may be secured to the torso (or some other body part) of the operator. The harness may be coupled to a first end of a lanyard. A second end of the lanyard may be coupled to one or more attachment points of the platform. The operator may further wear a jacket over the harness to protect the coupling of the harness to the first end of the lanyard, according to some embodiments. In some embodiments, a control system may be operable to ascertain various conditions associated with the PPE assembly. For example, the control system may determine whether the operator(s) present in the platform have their lanyard attached to the attachment point(s) on the platform. As another example, the control system may determine if the operator(s) are wearing the harness and/or the jacket. The control system may determine these and various other conditions associated with the PPE assembly and respond accordingly, which may include various alerts communicated aboard the platform, override operations of the lift assembly, alerts to a remote system, and so on. In some embodiments, the control system includes a camera and a controller (e.g., an embedded device, a processor and memory, etc.). The camera may be operable to collect image data of the environment in and/or around the platform in order to facilitate the determinations suggested above. In order for the controller to interpret the image data in order to perform the determinations suggested above, the control system may implement a neural network (e.g., a neural network model, machine learning, deep learning, deep neural network, etc.) in order to optimize the accuracy of such determinations.

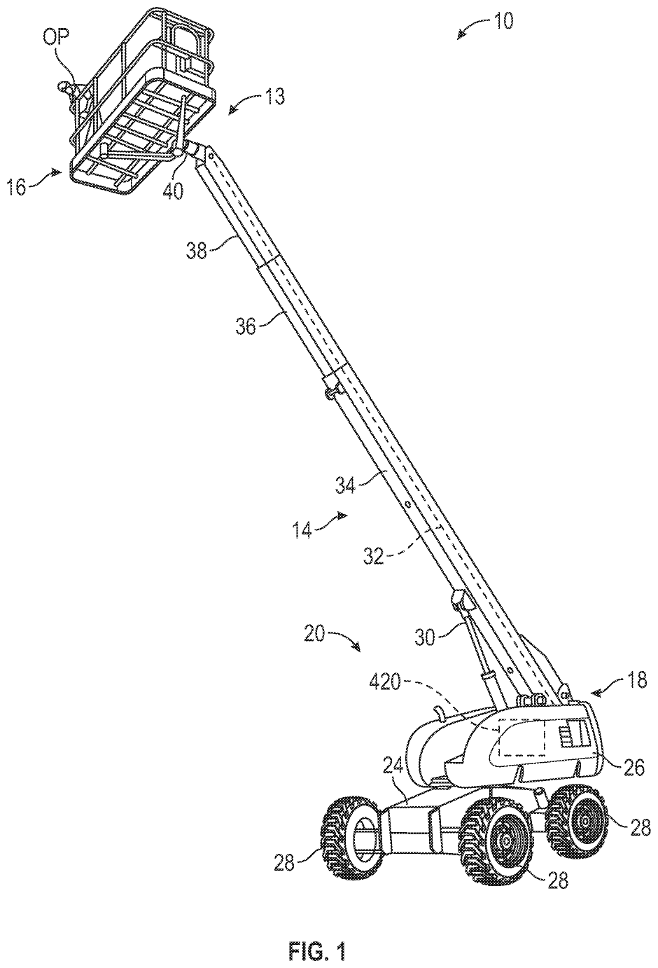

According to the exemplary embodiment shown in FIG. 1, a lift device (e.g., an aerial work platform, a telehandler, etc.), shown as lift device 10, includes a chassis or ground console, shown as chassis 20, and a work implement (e.g., a work platform, forks, a bucket, etc.), shown as platform assembly 16. The platform assembly 16 is coupled to the chassis 20 by a boom assembly or lift assembly, shown as boom 14. According to an exemplary embodiment, platform assembly 16 supports one or more operators (e.g., users, workers, etc.) 5. In some embodiments, the lift device 10 includes various accessories or tools coupled to the platform assembly 16 for use by the worker. For example, the platform assembly 16 may be equipped with pneumatic tools (e.g., impact wrench airbrush, nail guns, ratchets, etc.), plasma cutters, and spotlights, among other alternatives. While depicted herein as a boom lift, the lift device 10 may be configured as a different type of lift device, such as a telehandler, an articulating boom lift, a towable boom lift, a fully electric boom lift, a hybrid-electric boom lift, a vertical lift, a scissor lift, a mobile elevating work platform, a fire apparatus, etc. or any other type of device including a platform that supports one or more operators.

The boom 14 has a first or proximal end 18 pivotally coupled to the chassis 20 and a second or distal end 13 opposite the proximal end 18. The distal end 13 is pivotally coupled to the platform assembly 16. By pivoting the boom 14 at the proximal end 18, the platform assembly 16 may be elevated or lowered to a height above or below a portion of the chassis 20. The boom 14 has a plurality of telescoping segments that facilitate moving the distal end 13 and the platform assembly 16 closer to or away from the proximal end 18 and the chassis 20.

In some embodiments, the chassis 20 includes a chassis, base, or frame, shown as base frame 24. The base frame 24 is coupled to a turntable 26. According to exemplary embodiment, the proximal end 18 of the boom 14 is pivotally coupled to the turntable 26. According to an alternative embodiment, the chassis 20 does not include a turntable 26, and the boom 14 is coupled directly to the base frame 24 (e.g., the boom 14 may be provided as part of a telehandler). According to still another alternative embodiment, the boom 14 is incorporated as part of an articulating boom lift that includes multiple sections coupled to one another (e.g., a base section coupled to the chassis 20, an upper section coupled to the platform assembly 16, and one or more intermediate sections coupling the base section to the upper section, etc.).

In some embodiments, the lift device 10 is mobile and the base frame 24 includes tractive elements, shown as wheel and tire assemblies 28. The wheel and tire assemblies 28 may be driven using a prime mover and steered to maneuver the lift device 10. In other embodiments, the base frame 24 includes other devices to propel or steer the lift device 10 (e.g., tracks). In still other embodiments, the lift device 10 is a trailer that is towed by another vehicle, and the base frame 24 includes one or more wheels or elements configured to support the lift device 10. In still other embodiments, the lift device 10 is a stationary device and the base frame 24 lacks any wheels or other elements to facilitate the movement of the lift device 10 and may instead include legs or other similar structures that facilitate stationary support of the lift device 10.

The turntable 26 is coupled to the base frame 24 such that the turntable 26 may be rotated relative to the base frame 24 about a vertical axis of rotation (e.g., by a motor). According to an exemplary embodiment, the chassis 20 houses one or more pumps and/or motors that power one or more functions of the lift device 10 (e.g., extension and/or movement of the boom 14 and the platform assembly 16, rotation of the turntable 26, rotation of the wheel and tire assemblies 28, etc.). The pumps and/or motors may drive the movement directly, or may provide electrical energy or pressurized hydraulic fluid to another actuator. The lift device 10 may include an onboard engine (e.g., a gasoline or diesel engine), may receive electrical energy from an external source through a tether (e.g., a cable, a cord, etc.), may include an on-board generator set to provide electrical energy, may include a hydraulic pump coupled to a motor (e.g., an electric motor, an internal combustion engine, etc.), and/or may include an energy storage device (e.g., battery).

According to an exemplary embodiment, the turntable 26 includes an internal structure (e.g., one or more bosses coupled to a pin, etc.) configured to support the boom 14. The internal structure may interface with the proximal end 18 of the boom 14 to pivotally couple the boom 14 to the chassis 20. A lift actuator, shown as hydraulic cylinder 30, is coupled between the turntable 26 and the boom 14. According to an exemplary embodiment, the hydraulic cylinder 30 extends or retracts to raise or lower the boom 14 (e.g., to rotate the distal end 13 of the boom 14 relative to the turntable 26). In other embodiments, the hydraulic cylinder is replaced with or additionally includes another type of actuator (e.g., an electric motor, a lead screw, a ball screw, an electric linear actuator, a pneumatic cylinder, etc.).

According to an exemplary embodiment, the boom 14 is a telescoping boom including a series of segments or sections that are configured to translate relative to one another along a longitudinal axis 32. The longitudinal axis 32 extends along the length of the boom 14 between the proximal end 18 and the distal end 13. As shown in FIG. 1, the boom 14 includes three sections: a first or base boom section 34, a second, middle, or intermediate boom section 36, and a third, upper, or fly boom section 38. The base boom section 34 is the most proximal section, and the fly boom section 38 is the most distal section, with the intermediate boom section 36 extending between and coupling the base boom section 34 and fly boom section 38. The base boom section 34 is coupled to the turntable 26 and the fly boom section 38 is coupled to the platform assembly 16. The boom 14 may include an actuator (e.g., a hydraulic cylinder, an electric linear actuator, etc.) that controls telescoping of the boom 14.

According to an exemplary embodiment, the base boom section 34, the intermediate boom section 36, and the fly boom section 38 have tubular cross sectional shapes (e.g., to facilitate receiving boom sections within one another). The base boom section 34, the intermediate boom section 36, and the fly boom section 38 may have a variety of cross sectional shapes (e.g., hexagonal, round, square, pentagonal, etc.). While the embodiment shown in FIG. 1 has three boom segments, in other embodiments, the boom 14 includes more or fewer segments.

In some embodiments, the boom 14 further includes a linkage, shown as connecting linkage 40, which couples the platform assembly 16 to the fly boom section 38. According to an exemplary embodiment, the connecting linkage 40 includes a rotator (e.g., a rotating joint or motor, a hydraulic cylinder, etc.) that drives relative rotation between the boom 14 and the platform assembly 16. According to an exemplary embodiment, the connecting linkage 40 includes a jib (e.g., a four bar linkage) that facilitates translation between the boom 14 and the platform assembly 16.

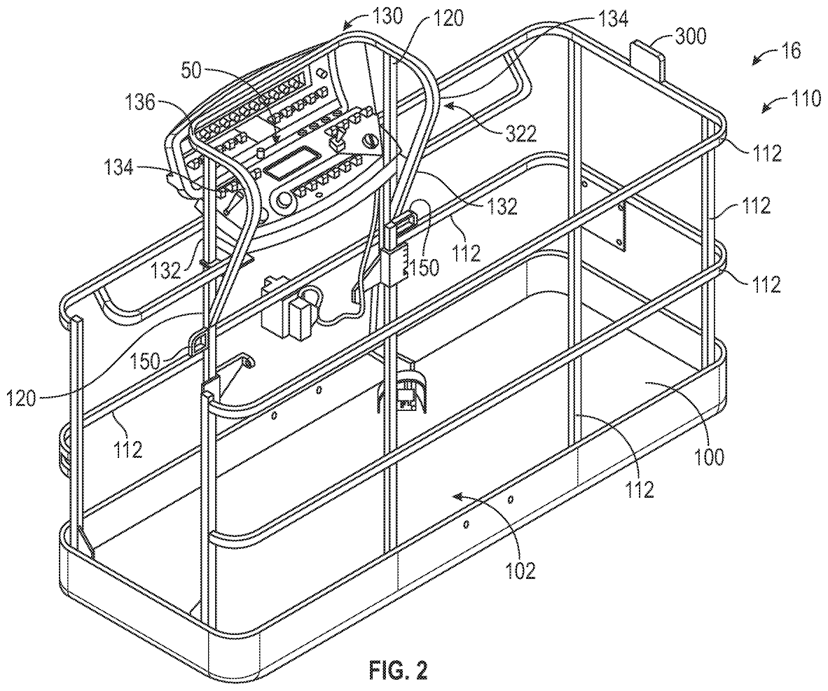

According to an exemplary embodiment, the connecting linkage 40 includes both a rotator and a jib. Such connecting linkages 40 may facilitate the platform assembly 16 remaining level as the boom 14 is raised or lowered. The connecting linkage 40 may be controlled by a self-leveling system including a slave cylinder (e.g., the slave cylinder may operate based on the position of the hydraulic cylinder 30). In other embodiments, movement of the connecting linkage 40 is otherwise controlled (e.g., by manual or computer control of a hydraulic or electric actuator (e.g., a cylinder, a motor, etc.). In some embodiments, the connecting linkage 40 supports a camera (such as a camera 300 as depicted with reference to FIG. 2) in order to perform the systems and methods herein related to a control system for a lanyard and PPE system, as described in greater detail below.

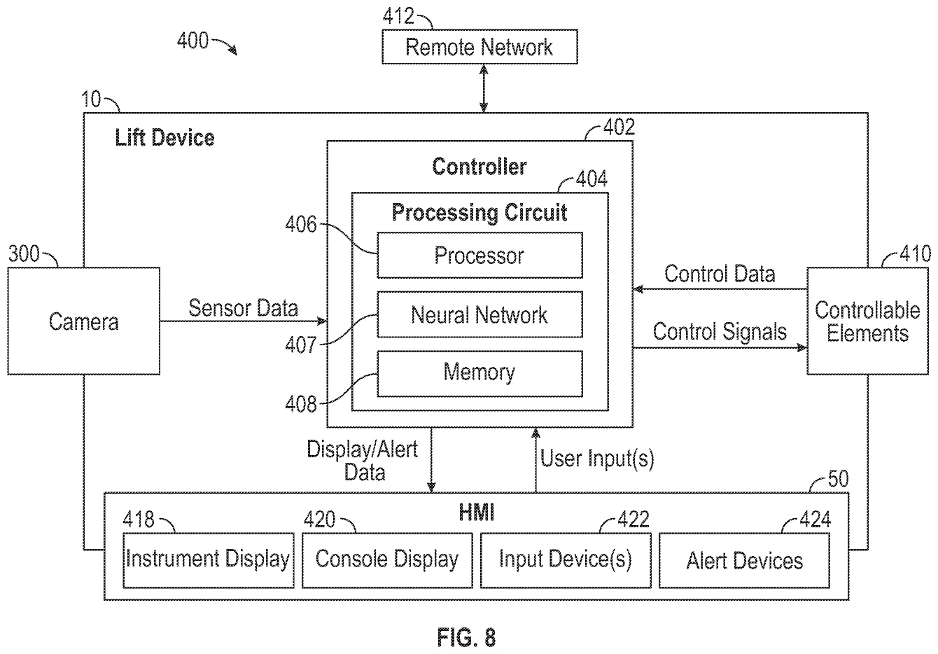

In some embodiments, the lift device 10 may include a controller 420 within the chassis 20 (or some other part of the lift device 10). The controller 420 may be part of a control system 400 (e.g., shown in FIG. 8) in order to perform the systems and methods described herein.

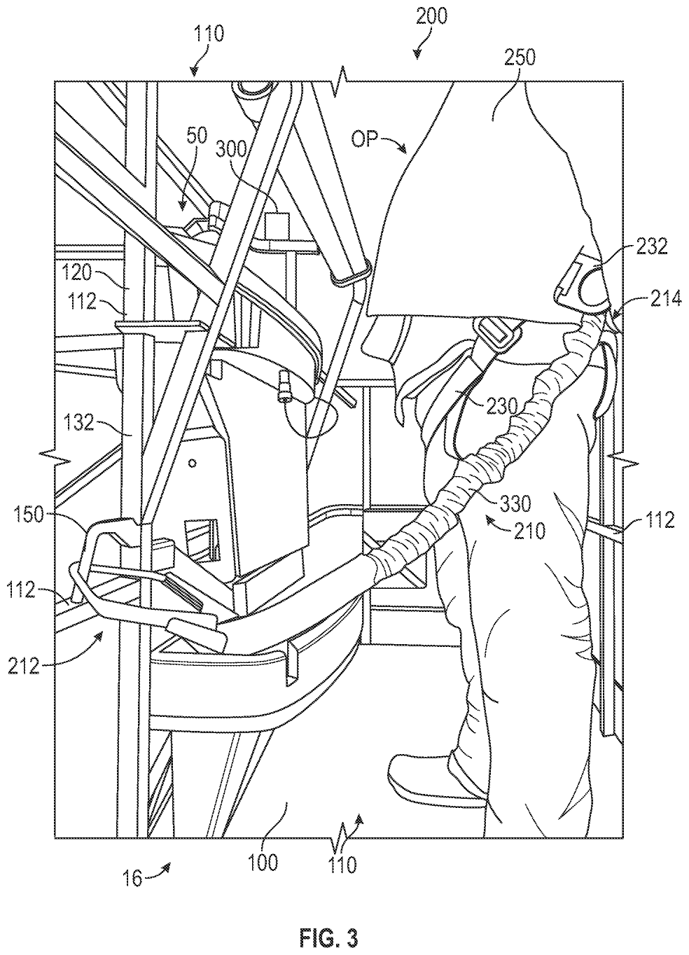

Referring now to FIGS. 2 and 3, the platform assembly 16 is shown in further detail. The platform assembly 16 is configured to provide a work area 102 for the operator OP of the lift device 10 to stand/rest upon. The platform assembly 16 can be pivotally coupled to the distal end 13 of the boom 14 (e.g., the connecting linkage 40). The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the chassis 20, or to a ground surface that the chassis 20 rests upon).

The platform assembly 16 can include a human machine interface (HMI) (e.g., an operator interface), shown as the HMI 50. The HMI 50 is configured to receive operator inputs from the operator at or upon the platform assembly 16 to facilitate operation of the boom 10. The HMI 20 can include any number of buttons, levers, switches, keys, etc., or any other operator input device configured to receive an operator input to operate the boom 10.

The platform assembly 16 includes a base member, a base portion, a platform, a standing surface, a shelf, a work platform, a floor, a deck, etc., shown as a deck 100. The deck 100 provides a floor surface for one or more workers to stand upon as the platform assembly 16 is raised and lowered. The worker may stand within the work area 102 positioned above the deck 100.

The platform assembly 16 includes a railing assembly 110 that extends upward from the deck 100 and at least partially surrounds the work area 102. The railing assembly 110 includes various members, beams, bars, guard rails, rails, railings, etc., shown as rails 112. The rails 112 extend along substantially an entire perimeter of the deck 100. The rails 112 provide one or more members for the operator of the lift device 10 to grasp while using the lift device 10 (e.g., to grasp while operating the lift device 10 to elevate the platform assembly 16) and contain the operator within the work area 102. The rails 112 can include members that are substantially horizontal to the deck 100. The rails 112 can also include vertical structural members that couple with the substantially horizontal members. The vertical structural members can extend upwards from the deck 100. One or more of the rails may be coupled to and support the HMI 50.

In some embodiments, the rails 112 include a pair of frame members, shown as vertical rails 120, that extend vertically upward from the deck 100. The vertical rails 120 are positioned on opposite sides of the HMI 50 such that the HMI 50 extends laterally between the vertical rails 120. A rail, shown as cage 130, is fixedly coupled to the vertical rails 120 and extends around the HMI 50. Specifically, the cage 130 extends laterally between the vertical rails 120, longitudinally forward of the vertical rails 120, and longitudinally rearward of the vertical rails 120. The cage 130 includes a pair of inclined portions 132, each extending longitudinally forward and vertically upward from a middle portion of one of the vertical rails 120. The cage 130 further includes a pair of curved portions 134, each coupled to an upper end of one of the inclined portions 132. The curved portions 134 each extend upward and longitudinally rearward from the corresponding inclined portion 134. A u-shaped horizontal portion 136 is coupled to both of the curved portions 134. The horizontal portion 136 extends longitudinally rearward from the curved portions 134 and laterally between the curved portions 134. The horizontal portion 136 is coupled to the top end of each vertical rail 120. The curved portions 134 and the horizontal portion 136 both extend above the HMI 50.

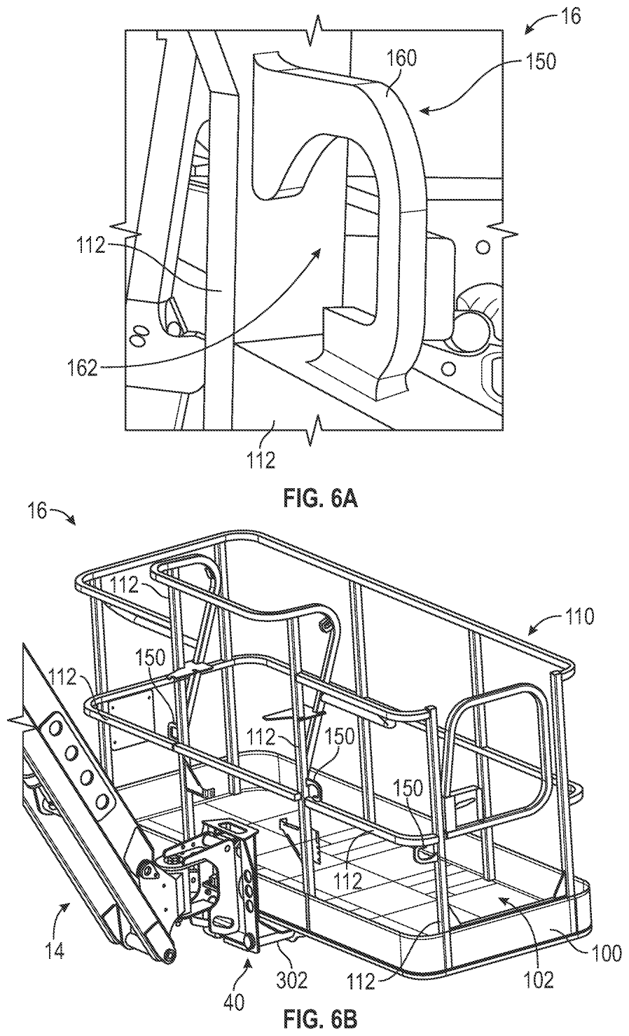

As shown in FIGS. 2, 3, 6A, and 6B, the platform assembly 16 includes a series of attachment points (e.g., loops, receivers, hooks, eyes, etc.), shown as attachment points 150. The attachment points 150 may extend from (e.g., may be fixedly coupled to) one of the vertical rails 120 or other point on the rail assembly 110. As shown in FIG. 6A, an attachment point 150 includes a body or hook, shown as curved member 160. The curved member 160 has a first end fixedly coupled (e.g., welded) to a vertical frame rail 112 and a second end fixedly coupled to a horizontal frame rail 112. An aperture 162 is defined between the curved member 160, the vertical frame rail 112, and the horizontal frame rail 112.

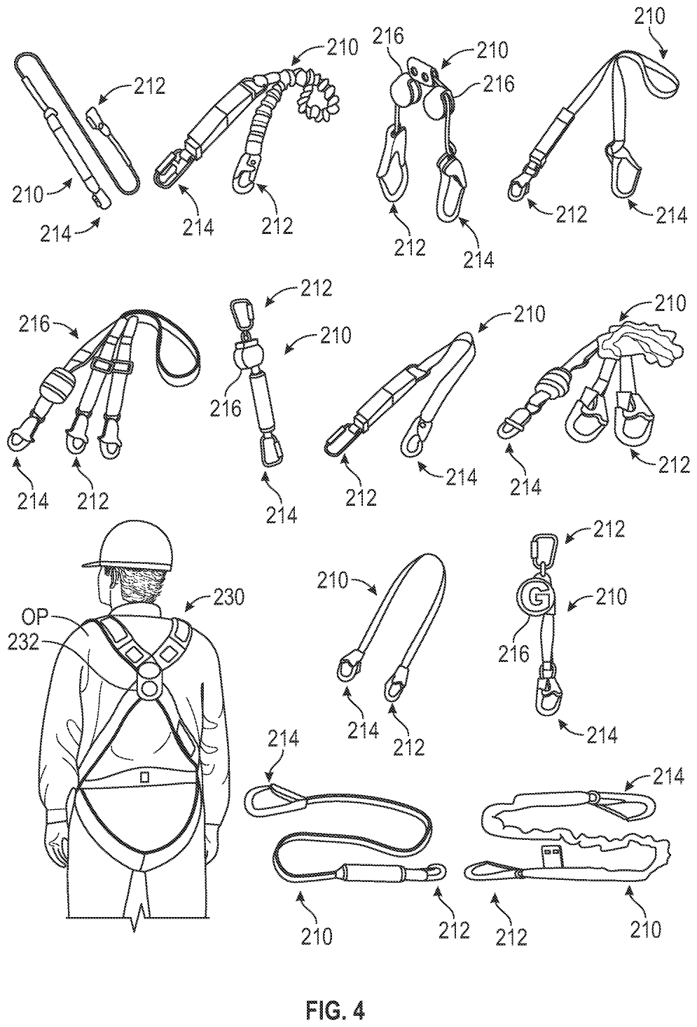

Referring to FIG. 3, a personal protective equipment (PPE) system 200 for the lift device 10 is shown according to an exemplary embodiment. The PPE system 200 includes a tensile member, shown as lanyard 210. The attachment points 150 may each receive an end of a lanyard 210 (e.g., depicted in various embodiments with reference to FIG. 4) in order to secure the operator OP to the platform assembly 16 (e.g., on top of the deck 100). For example, the lanyard 210 may include a first end 212 and a second end 214. The first end 212 may include a mechanical device or coupler (e.g., a hook, claw, carabiner, cuff, etc.) configured to engage (e.g., receive) the attachment point 150, in order to provide a secure selective coupling of the first end 212 of the lanyard 210 to the platform assembly 16. By way of example, a hook of the first end 212 may extend around the curved member 160 and extend through the aperture 162. The lanyard 210 may further include a second end 214 with a second mechanical device or coupler configured to be coupled to a brace, shown as harness 230, of the PPE system 200.

Referring to FIG. 4, the harness 230 is worn by and secured to the operator OP. By of example, the harness 230 may include straps that define apertures that receive the limbs (e.g., arms and legs) of the operator OP. In some embodiments, the lanyard 210 can be sized so that the operator OP can move to specified locations about the platform assembly 16 (e.g., up to the perimeter of the platform assembly 16 as defined by the rails 112, up to a point outside the perimeter of the platform assembly 16 such that the operator OP can partially lean out of the perimeter of the platform assembly 16, throughout the work area 102, and so on, as defined by various implemented safety metrics for operation of the lift device 10). The harness 230 further includes an interface, shown as ring 232, that is configured to engage (e.g., selectively couple to) the second end 214 of the lanyard 210.

The operator OP may further wear an outer clothing layer (e.g., a vest, a coat, a jacket, etc.), shown as jacket 250 of the PPE system 200. The jacket 250 may be sized and otherwise configured to be worn over the harness 230, such that the second end 214 may be securely coupled to the harness 230 while also preventing contact to the harness 230 that might obstruct the integrity of the harness 230 and lanyard 210. As shown in FIG. 4, the jacket 250 defines an aperture through which the ring 232 extends. Together, the harness 230, the jacket 250, the lanyard 210, and the attachment point 150 may form the PPE system 200.

Referring now to FIG. 4, the lanyard 210 and the harness 230 are shown according to various embodiments. The PPE system 200 may be usable with a variety of interchangeable lanyards 210 and harnesses 230. The configuration of the first end 212 and the second end 214 of the lanyard 210 may be varied. By way of example, the first end 212 and the second end 214 may each include one or more (e.g., two) hooks to interface with the attachment point 150 or the ring 232. In some embodiments, the lanyard 210 includes one or more reels that vary a length of the lanyard 210. In the harness 230, the ring 232 may be positioned along the back and/or the side of the operator OP.

Referring now to FIG. 6B, the platform assembly 16 includes three attachment points 150. In some embodiments, the PPE system 200 may be configured to have a single harness 230 coupled to multiple attachment points 150 via multiple lanyards 210. In other embodiments, the platform assembly 16 may be configured to support multiple operators OP, and thus include at least one attachment point 150 for each of the operators OP. By way of example, each operator 150 may be outfitted with a corresponding lanyard 210, harness 230, and vest 250.

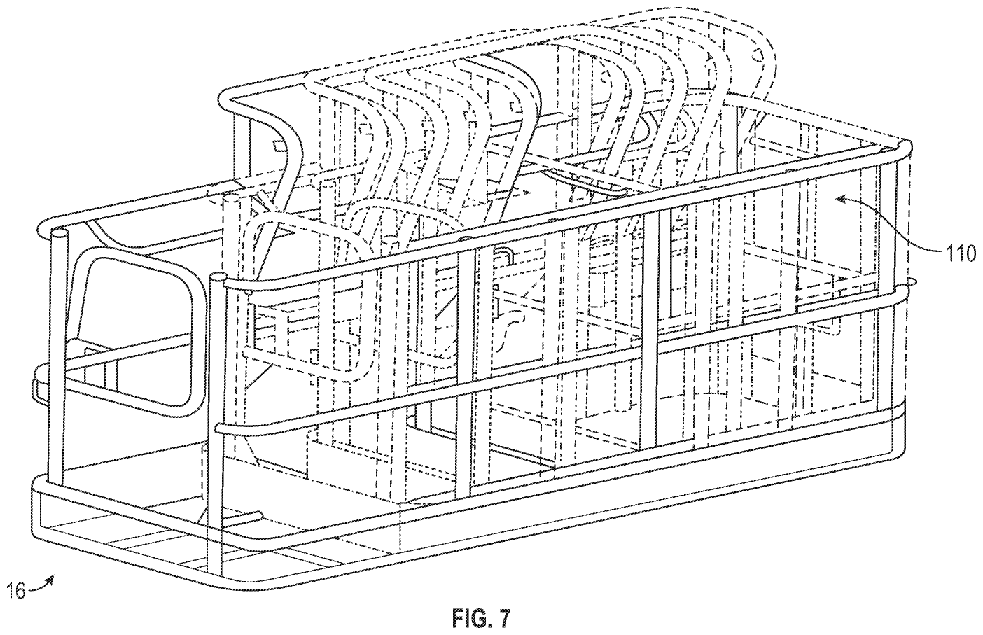

Referring now to FIG. 7, the platform assembly 16 is shown according to various embodiments of different dimensions. For example, platform dimensions may include: (i) (ii) 30″×48″; (iii) 36″×60″; (iv) 30″×72″; (v) 36″×72″; (vi) 36″×96″; and so on. In FIG. 7, each different line type (e.g., solid, dashed, etc.) represents a different size (e.g., width) the platform 16.

Referring to FIGS. 2, 3, and 5, the lift device 10 includes a sensor, shown as camera 300, that monitors a state or condition (e.g., operation, integrity, engagement, etc.) of the PPE system 200. In some embodiments, the camera 300 may collect image data in and around the platform assembly 16. Such image data may be used to determine whether the operator OP (if present aboard the platform assembly 16) has the lanyard 210 attached to the attachment point 150. Such image data may further be used to determine whether the operator OP is wearing the harness 230 and the jacket 250. Such image data may be transmitted to a controller (e.g., the controller 420 of FIG. 8) in order to perform such determinations.

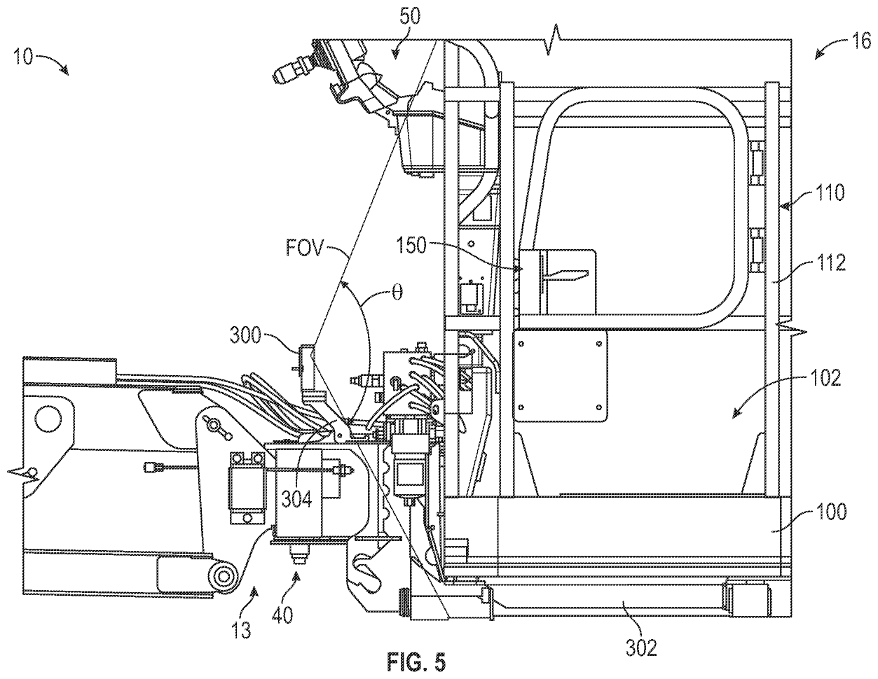

The camera 300 may be mounted (e.g., coupled, welded, attached, supported by, etc.) in a location that, depending on the viewable scope of the camera 300, allows the camera 300 to collect image data as necessary for the control system 400 to perform the systems and methods described herein. As shown in FIG. 5, the camera 300 is coupled to the platform 16, such that a position and orientation (e.g., pose) of the camera 300 relative to the platform 16 is fixed. An arm 302 extends beneath the platform 16 and is fixedly coupled to the platform 16. A bracket 304 extends upward from the arm 302, and the camera 300 is fixedly coupled to a distal end of the bracket 304. The bracket 304 is coupled to the connecting linkage 40. By fixing the position and orientation of the camera 300 relative to the platform 16, the platform 16 maintains a fixed position in a field of view FOV of the camera 300, as shown in FIG. 5, regardless of the movement of the boom 14.

The placement of the camera 300 in FIG. 5 may avoid obstruction of the camera 300. The platform assembly 16 may be intended to carry one or more operator(s) OP along with other tools and equipment. The operator OP may carry their toolbox and place the toolbox immediately behind the attachment point 150, the operator OP may place a generator that may partially obstruct a line of sight toward the attachment point 150 from the work area 102, or the operator OP may stand right behind the attachment point 150, blocking the view of the access point 150 from certain directions. The placement of the camera 300 in FIG. 5 at a location forward of the railing 110 may avoid such obstacles.

As shown in FIGS. 2 and 3, the camera 300 may alternatively be mounted (e.g., coupled, welded, attached, supported by, etc.) to the rails 112. In other embodiments, the camera 300 may be mounted on the connecting linkage 40, or some other part of the lift device 10 that moves relative to the platform 16. Accordingly, the camera 300 may be disposed at various locations around platform assembly 16 to provide image data (or other useful information) to the controller 402.

The field of view FOV of the camera 300 may be substantially conical and have an angle Θ. In some embodiments, the camera 300 includes a 180° wide angle (i.e., the angle θ is) 180°. In some embodiments, the camera 300 provides image data in accordance with a 1280×960 pixel distribution with MJPEG or H.265 compression. In other embodiments, the camera 300 provides image data with a 1920×1080 pixel distribution. In other embodiments still, the camera 300 is configured differently (e.g., 360° image data, other pixel distributions, etc.).

While depicted herein as including a camera 300, the lift device 10 can include, or in fact be, other sensors. For example, the lift device 10 can be or include any one and/or a combination of camera(s), proximity sensor(s), infrared sensor(s), electromagnetic sensor(s), capacitive sensor(s), photoelectric sensor(s), inductive sensor(s), radar sensor(s), ultrasonic sensor(s), Hall Effect sensor(s), fiber optic sensor(s), Doppler Effect sensor(s), magnetic sensor(s), laser sensor(s) (e.g., LIDAR sensors), sonar sensor(s), and/or the like. Accordingly, any reference herein to the camera 300 may also apply to these other types of sensors.

In some embodiments, the camera 300 includes an image capture device such as visible light cameras, full-spectrum cameras, image sensors (e.g., charged-coupled device (CCD), complementary metal oxide semiconductor (CMOS) sensors, etc.), or any other type of suitable object sensor or imaging device. Sensor data captured by the camera 300 may include, for example, raw image data from one or more cameras (e.g., visible light cameras) and/or proximity data from one or more sensors (e.g., LIDAR, radar, etc.) that may be used to detect objects. In other embodiments, sensor data captured by the camera 300 is video feed data obtained from the camera 300 regarding one or more areas in and/or surrounding platform assembly 16. For example, the sensor data may be or include video feed data (e.g., live or real-time video feed data) of the front, sides, rear, and/or interior of the platform assembly 16. In some embodiments, multiple cameras 300 may be used in order to provide multiple feeds of image data to the controller 420, which may be configured to compile (e.g., cross-reference based on known relative locations of the multiple cameras 300) the image data.

In some embodiments, the camera 300 is active during operation of the platform assembly 16. Additionally or alternatively, the camera 300 may become active in response to a detected operation mode of the platform assembly 16. For example, the camera 300 may activate in response to another sensor (e.g., a low-power camera, a motion detector, etc.) detecting the presence of the operator OP aboard the platform assembly 16.

In some embodiments, the camera 300 (e.g., in conjunction with the control system 400) is configured to determine a number of operator(s) 5 (e.g., 1, 2, 3, 5, etc.) about (e.g., supported by, standing on) the platform assembly 16. In some embodiments, an additional camera 300 (or a different camera or other detection device) may be positioned on or around the HMI 50 (or on the rails 112) in order to determine the number of operators OP present. The camera 300 and/or control system 400 may in turn provide individual determinations regarding multiple attachment points 150, lanyards 210, harnesses 230 and/or jackets 250 with respect to the multiple operators OP in terms of assessing the integrities of the lanyard and PPE systems.

Referring now to FIG. 8, a block diagram of the control system 400 is shown, according to some embodiments. The control system 400 may include the camera 300, the controller 402, a remote network 412, controllable elements 410, and the HMI 50. As shown in greater detail, the HMI 50 may include various displays and user input devices 422 (e.g., buttons, switches, levers, dials, joysticks, etc.), for operation of lift device 10. As shown, the HMI 50 may include displays, shown as instrument display 418 and console display 420, input devices, shown as input devices 422, and alert devices or alarms, shown as alert devices 424. In some embodiments, the displays such as instrument display 418 and console display 420 are also input devices, such as touchscreens, and are able to receive operator inputs (e.g., from the operator OP) in addition to input devices 422. In some embodiments, the HMI 50 is configured to obtain operator inputs from input devices 422 input and provide the operator inputs to the controller 402. In other words, while configured to perform the determinations herein regarding the integrity of the lanyard and PPE system, the controller 402 may be further configured to facilitate general operation of the lift device 10. The operator inputs can indicate a desired operation and/or operational state of lift device 10 or of an apparatus, system, device, sub-system, assembly, etc., of lift device 10. For example, the operator inputs can indicate a requested operation of the lift assembly 14. Controller 402 may respond to the operator inputs by automatically adjusting the information provided to the user via HMI 50 by providing HMI 50 with display data, initiating an automatic alert via HMI 50 via alert devices 424, and/or initiating an automatic action. In some embodiments, the operator OP may provide operator inputs indicating that the operator OP has entered the platform assembly 16 and/or is leaving the platform assembly 16, in order to active, deactivate, or otherwise adjust the function of the controller 402 with respect to assessing the integrity of the PPE system 200.

In some embodiments, alert devices 424 can provide auditory alerts to an operator of lift device 10. Alert devices 424 may include speakers, sound output devices, alarms, buzzers, etc. based on the display/alert data provided by controller 402. In some embodiments, alert devices 424 are associated with a corresponding automatic action undertaken by the control system 400. For example, an audible alert or alarm, such as audible natural language based alerts, indicating that the PPE system 200 is not fully functional may can accompany a corresponding action, such as limiting operation of the lift device 10, initiated by the control system 400. The audible natural language based alerts can accord to one or more languages.

In some embodiments, the controller 402 may receive image data from the camera 300 as described herein. The controller 402 may include a processing circuit 404, which may include a processor 406 and a memory 408, that facilitates performance of the systems and methods described herein. For example, the processor 406 may receive the image data and perform object detection (e.g., detecting an object-of-interest) in order to assess the integrity of the PPE system 200 as suggested above. Further, the processor 406 may be configured to compile and utilize a neural network 407 in order to perform the systems and methods described herein. In order to implement the neural network 407 on a device, such as the lift device 10, multiple neural networks 407 may be developed in phases in order to optimize the performance of the control system 400.

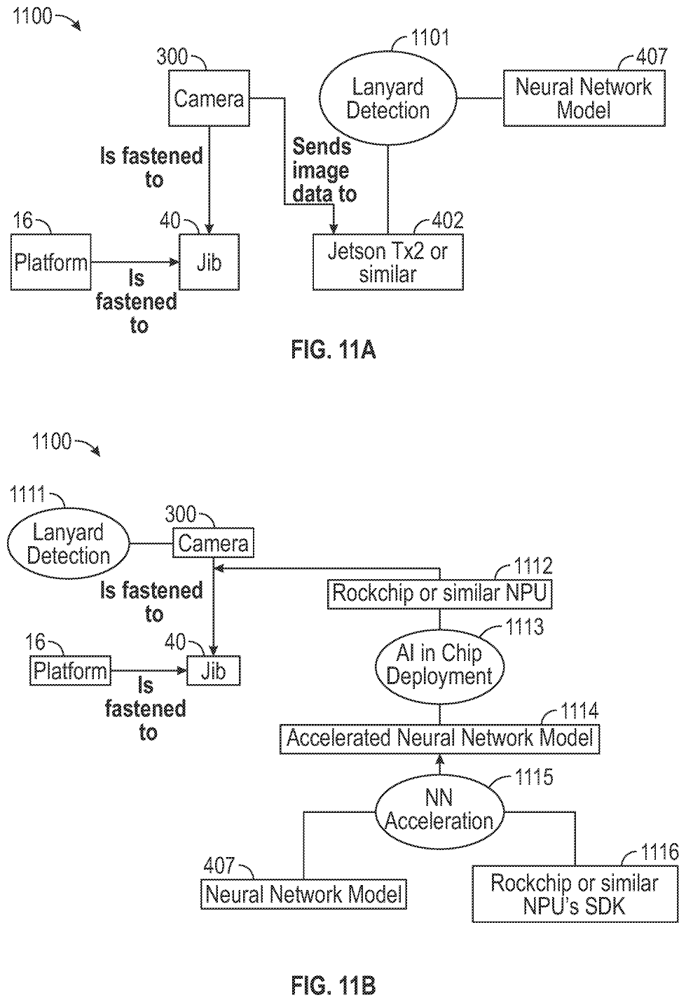

In some embodiments, the control system 400 may operate to constantly assess the integrity of the PPE system 200. Where the control system 400 determines a failure of the integrity (e.g., the lanyard 210 is not coupled to the attachment point 150, the operator is not wearing the harness 230 and/or the jacket 250, the harness 230 is not coupled to the lanyard 210, etc.), the control system 400 may function to provide one or more alerts to the HMI 50 as described above. The control system 400 may further function to adjust the operation of the lift device 10 via the controllable elements 410 (e.g., cease movement of the lift device 10, lower the lift assembly 14 to the ground, etc.). The control system 400 may further function to alert a remote device (such as a supervisor of the operator OP) over a remote network 412 in communication with the lift device 10. The particular function of the control system 400 is depicted in greater detail below with reference to FIGS. 11A and 11B.

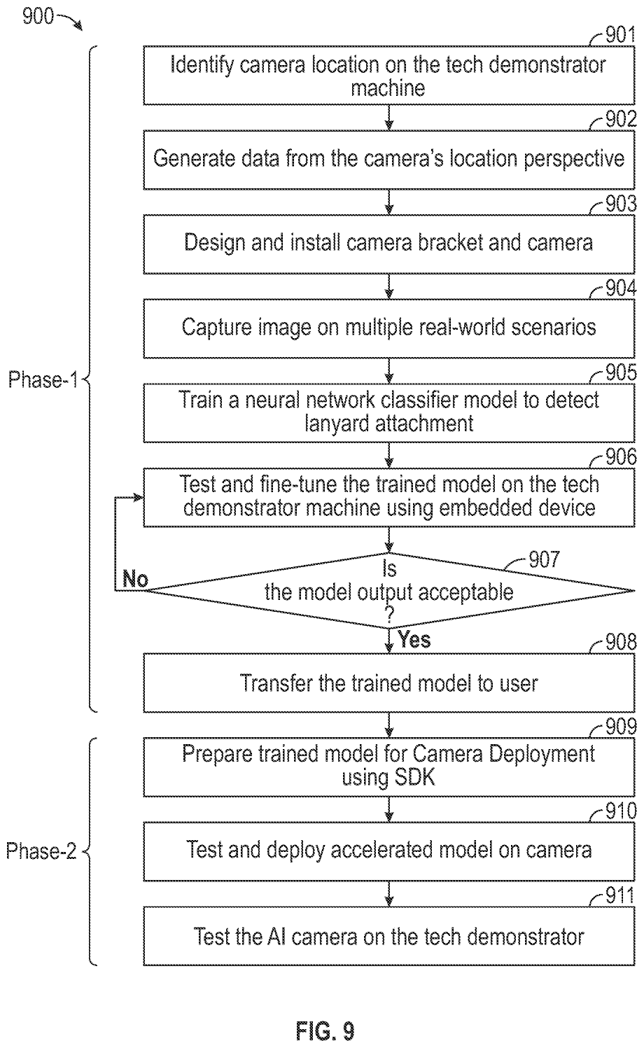

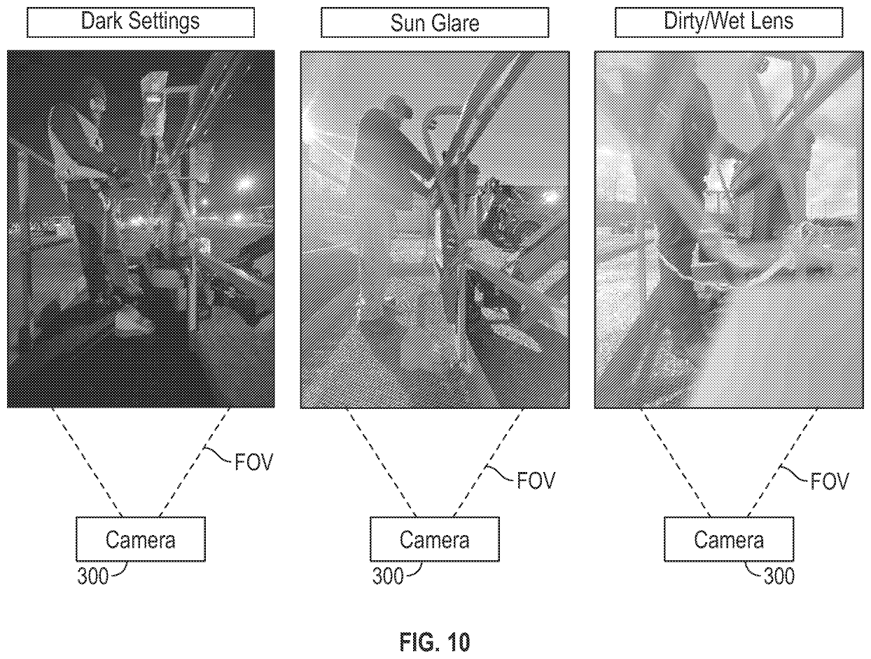

Referring now to FIG. 9, a process for implementing (e.g., providing) the control system 400 (e.g., systems and methods for assessing the integrity of the PPE system 200 as described herein) to a device, such as the lift device 10, is shown, according to some embodiments. At processes 901-903, the camera 300 may be identified in a simulated environment (e.g., relative to an expected platform assembly 16). Simulated data may thus be generated (e.g., synthetic data, operating data, test data, etc.) based on the camera 300's expected mounting location on a demonstration device, which may be the lift device 10. The generated data may be collected for multiple real-world scenarios at process 904, as shown with reference to FIG. 10. The generated data may be used as training data in order to develop a neural network classifier model (e.g., the neural network 407) for assessing the integrity of the lanyard and PPE system at process 905. At processes 906 and 907, the control system 400 may be applied to a demonstration device, such as the actual lift device 10 in order to iteratively test the performance of the control system 400. For example, the neural network 407 may be implemented on the controller 402, which may be implemented as the camera 300's neural processing unit (NPU), or separately (e.g., the camera 300 may simply provide the image data to a separately located controller 402, and the controller 402 may provide the NPU. A software development kit (SDK) for the provided NPU (e.g., provided by a chip manufacturer such as Rockchip) SDK for Rockchip may thus be provided along with the trained neural network model 407 from processes above to accelerate or otherwise optimize the function and/or implementation of the control system 400. At process 908, the control system 400, the camera 300, the neural network model 407, and/or the lift device 10 as a whole (depending on the implementation of the processes above) may assembled and provided. At processes 909-911 the control system 400 may be tested further on the provided assembly, which may be based on the software development kid (SDK) used to generate the neural network model 407 at processes 901-907. Upon the completion of process 911, the control system of the lift device 10 may be considered implemented in accordance with performing the systems and methods described herein.

Referring now to FIG. 10, the control system 400 (and the camera 300 therein) may be operable in various real-world environments. For example, in practical use, machines such as the lift device 10 may be used all day across the globe in different lighting and weather conditions (e.g., a dark or night environment, a bright environment that produces glare, an environment that introduces debris, such as water or dirt, onto a lens of the camera 300, etc.). The trained neural network model 407 may be configured to correctly detect if an operator has their lanyard hook attached to the attachment point 150 or not in various lighting conditions. As suggested above with reference to FIG. 9, various real-world conditions may be simulated or tested to train the neural network model 407 in accordance with such scenarios. Further, the platform assembly 16, when raised up in the air by the lift device 10 may, at times, experience wind forces which will cause the platform assembly 16 to oscillate. The camera 300 and/or the neural network model 407 may be configured to compensating the image blur or distortion caused by this wind and movement.

Referring now to FIG. 11, flows 1100 and 1110 are depicted in accordance with exemplary operation(s) of the control system 400, according to some embodiments. For example, and with specific reference to FIG. 11A, the platform 16 may be coupled to the jib (e.g., connecting linkage) 40. The platform 16 and/or the connecting linkage 40 may support the camera 300. The camera 300 may provide image data to the controller 402, which may be an embedded device such as a Jetson TX2 or a similarly operable system. The controller 402 may in turn produce a lanyard detection signal 1101 in accordance with the neural network model 407 as described above. As another example, and with specific reference to FIG. 11B, trained neural network model 407 may be combined (e.g., cross-referenced, integrated, assembled, etc.) with the provided NPU SKD 1116 (as suggested above) in order to provide an accelerated/optimized neural network model 1114 (which may be simply discussed as the neural network model 407 above for clarity). The accelerated neural network model 1114 may in turn enable artificial intelligence for a deployment of the NPU of the camera 300 (or the control assembly 400/controller 402 as a whole), as shown by AI in Chip Deployment 1113. The AI in Chip Deployment 1113 may in turn be provided as an NPU 1112 for the actual camera 300, controller 402, and/or control system 400 for the lift device 10, which may enable the camera 300 to perform lanyard detection 1111 (separately or in conjunction with the controller 402 and/or the control assembly 400).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A lift device, comprising:
a chassis;
a platform configured to support an operator, the platform including an attachment point configured to engage a lanyard to secure the operator to the platform;
a lift assembly coupling the platform to the chassis and configured to raise the platform relative to the chassis;
a camera having a field of view that includes the attachment point and configured to provide sensor data indicative of engagement between the attachment point and the lanyard;
a bracket fixedly coupling the camera to the platform such that the field of view is fixed relative to the platform, wherein the platform includes a railing at least partially surrounding a work area of the platform, and wherein the camera is coupled to the bracket outside of the work area; and
a controller operatively coupled to the camera and configured to:
determine, based on the sensor data, if the lanyard is engaged with the attachment point; and
in response to a determination that the lanyard is not engaged with the attachment point, at least one of (a) activate an alarm to provide a notification to alert the operator that the lanyard is not engaged with the attachment point or (b) limit movement of the lift device.

2-4. (canceled)

5. The lift device of claim 1, wherein the attachment point is a first attachment point, wherein the platform includes a second attachment point, and wherein the field of view of the camera includes the first attachment point and the second attachment point.

6. A lift device, comprising:
a chassis;
a platform configured to support a first operator and a second operator of a plurality of operators, the platform including (a) a first attachment point configured to engage a first lanyard to secure the first operator to the platform and (b) a second attachment point configured to engage a second lanyard to secure the second operator to the platform;
a lift assembly coupling the platform to the chassis and configured to raise the platform relative to the chassis;
a camera having a field of view that includes the first attachment point and the second attachment point, the camera being configured to provide sensor data indicative of engagement between the first attachment point and the first lanyard; and
a controller operatively coupled to the camera and configured to:
determine, based on the sensor data, a number of the operators that are currently supported by platform;
determine, based on the sensor data, if the first lanyard is engaged with the first attachment point;
in response to a determination that the first lanyard is not engaged with the first attachment point, at least one of (a) activate an alarm to provide a notification to alert the operators that the first lanyard is not engaged with the first attachment point or (b) limit movement of the lift device;
determine, based on the sensor data, if the second lanyard is engaged with the second attachment point; and
in response to a determination that both (a) at least two of the operators are supported by platform and (b) the second lanyard is not engaged with the second attachment point, at least one of (a) activate the alarm to provide a notification to alert the operators that the second lanyard is not engaged with the second attachment point or (b) limit the movement of the lift device.

7. The lift device claim 1, wherein the controller is configured to activate the alarm to provide the notification in response to the determination that the lanyard is not engaged with the attachment point.

8. The lift device of claim 7, wherein the notification is an auditory alert.

9. The lift device claim 1, wherein the controller is configured to limit the movement of the lift device in response to the determination that the lanyard is not engaged with the attachment point.

10. A lift device, comprising:
a chassis;
a platform configured to support an operator, the platform including an attachment point configured to engage a lanyard to secure the operator to the platform;
a lift assembly coupling the platform to the chassis and configured to raise the platform relative to the chassis;
a sensor configured to provide sensor data indicative of engagement between the attachment point and the lanyard; and
a controller operatively coupled to the sensor and configured to:
determine, based on the sensor data, if the lanyard is engaged with the attachment point; and
control the lift assembly to lower the platform in response to the determination that the lanyard is not engaged with the attachment point.

11. The lift device of claim 1, wherein the controller is configured to both (a) activate the alarm to provide the notification to alert the operator that the lanyard is not engaged with the attachment point and (b) limit the movement of the lift device in response to the determination that the lanyard is not engaged with the attachment point.

12. The lift device of claim 1, wherein the attachment point defines an aperture configured to receive a hook of the lanyard.

13. The lift device of claim 12, wherein the attachment point is a first attachment point, wherein the platform includes a railing at least partially surrounding a work area of the platform, and wherein the first attachment point and a second attachment point are at least partially defined by the railing.

14. A lift device, comprising:
a chassis;
a platform configured to support an operator, the platform including an attachment point configured to engage a lanyard to secure the operator to the platform;
a lift assembly coupling the platform to the chassis and configured to raise the platform relative to the chassis;
a sensor configured to provide sensor data indicative of engagement between the attachment point and the lanyard; and
a controller operatively coupled to the sensor and configured to:
determine, based on the sensor data, if the lanyard is engaged with the attachment point;
in response to a determination that the lanyard is not engaged with the attachment point, at least one of (a) activate an alarm to provide a notification to alert the operator that the lanyard is not engaged with the attachment point or (b) limit movement of the lift device;
determine, based on the sensor data, if the operator is wearing a harness coupled to the lanyard; and
in response to a determination that the operator is not wearing the harness coupled to the lanyard, at least one of (a) control the alarm to provide a notification to alert the operator that the lanyard is not engaged with the attachment point or (b) limit the movement of the lift device.

15. A control method, comprising:
receiving image data from a camera having a field of view that includes a work area of a platform;
determining, based on the image data, if a personal protective equipment (PPE) system is securing an operator to an attachment point of the platform; and
in response to a determination that the PPE system is not securing the operator to the attachment point, controlling an alarm to provide a notification to alert the operator and preventing a boom assembly from lifting the platform.

16. The control method of claim 15, wherein determining if the PPE system is securing the operator to the attachment point includes determining if a lanyard of the PPE system is engaged with the attachment point based on the image data.

17. A control method, comprising:
receiving image data from a camera having a field of view that includes a work area of a platform;
determining, based on the image data, if a personal protective equipment (PPE) system is securing an operator to an attachment point of the platform at least by determining if a harness of the PPE system is worn by the operator based on the image data; and
in response to a determination that the PPE system is not securing the operator to the attachment point, controlling an alarm to provide a notification to alert the operator.

18. (canceled)

19. A control method, comprising:
receiving image data from a camera having a field of view that includes a work area of a platform;
identifying, based on the image data, a first operator and a second operator present within the work area;
determining, based on the image data, if a first harness is worn by the first operator and a first lanyard is coupling the first harness to the platform;
determining, based on the image data, if a second harness is worn by the second operator and a second lanyard is coupling the second harness to the platform;
determining that a personal protective equipment (PPE) system is not operational in response to at least one of (a) a determination that the first harness is not worn by the first operator, (b) the first lanyard is not coupling the first harness to the platform, (c) a determination that the second harness is not worn by the second operator, or (d) the second lanyard is not coupling the second harness to the platform; and
limiting operation of a lift assembly to prevent upward movement of the platform in response to a determination that the PPE system is not operational.

20. The control method of claim 19, further comprising controlling an alarm to provide a notification in response to the determination that the PPE system is not operational.
